(19) United States
(12) Patent Application Publication
(10) Pub. No.: US 2019/0217400 A1
(43) Pub. Date: Jul. 18, 2019

(54) Quick Release Adapter

(71) Applicant: Robert Bosch GmbH, Stuttgart (DE)

(72) Inventors: Donghui Ding, Zhenjiang (CN); Daniel Grolimund, Zuchwil (CH); Kai Wu, Hangzhou City (CN)

(21) Appl. No.: 16/307,692

(22) PCT Filed: May 17, 2017
(86) PCT No.: PCT/EP2017/061785

§ 371 Date: Dec. 6, 2018

(30) Foreign Application Priority Data
Jun. 6, 2016 (DE) 10 2016 209 867.5

(51) Int. Cl. B23B 31/107

(52) U.S. Cl. CPC B23B 31/1071

(57) ABSTRACT

A quick release adapter for operating an application tool on a portable power tool includes a drive shaft and a receiving portion. The drive shaft is configured to be arranged in a tool receptacle of the portable power tool. The receiving portion is connected to the drive shaft and is provided with an internal receptacle. The internal receptacle is configured to receive an output shaft. The output shaft has an internal receptacle for receiving an application tool. The internal receptacle of the output shaft is configured at least regionally in a sleeve-like manner and at least regionally has an internal protruding part. The application tool has an at least regionally cylindrical shank with at least one external flat region adapted to the at least one internal protruding part.

### PRIOR ART

The present invention relates to a quick-release adapter for operating an insert tool on a portable power tool, having a drive shaft for arranging in a tool holder of the portable power tool, and having an accommodating portion, which is connected to the drive shaft and is provided with an internal holder.

EP 1 193 014 B1 discloses such a quick-release adapter for operating an insert tool on a portable power tool. The quick-release adapter has a drive shaft for arranging in a tool holder of the portable power tool and also has an accommodating portion, which is provided with an internal holder. The internal holder here is of a hexagonal design in order to receive an insert tool, wherein the insert tool has a hexagonal shank for arrangement in the respective internal holder.

### DISCLOSURE OF THE INVENTION

The present invention provides a novel quick-release adapter for operating an insert tool on a portable power tool, having a drive shaft for arranging in a tool holder of the portable power tool and having an accommodating portion, which is connected to the drive shaft and is provided with an internal holder. The internal holder is designed to accommodate an output shaft, wherein the output shaft has an internal holder for accommodating an insert tool, wherein the internal holder of the drive shaft is at least partially of a sleeve-like design and, at least in part, has an internal-convexity part, and wherein the insert tool has an at least partially cylindrical shank with at least one external flattened region, which is adapted to the at least one internal-convexity part.

The invention therefore makes it possible to provide a quick-release adapter in the case of which the at least one internal-convexity part in the internal holder and the at least one external flattened region, which is adapted to the at least one internal-convexity part, can provide for easy and precise centering of the insert tool in the quick-release adapter. It is thus possible to provide for sure and reliable transmission of a torque from the quick-release adapter to the insert tool.

The internal holder of the accommodating portion is preferably designed to accommodate a coupling part, wherein the coupling part has an internal holder for accommodating the output shaft. It is therefore easily possible to provide for coupling between the accommodating portion and the output shaft.

The internal holder of the accommodating portion is preferably at least partially of a sleeve-like design and, at least in part, has at least one internal convexity, wherein the coupling part has an at least partially cylindrical external circumference with at least one external flattened formation, which is adapted to the at least one internal convexity. A suitable internal holder can therefore be provided in an easy and uncomplicated manner.

According to one embodiment, the at least one partial external flattened formation and/or the at least one partial external flattened region are/is designed to transmit torque. It is thus possible to provide for sure and reliable torque transmission.

It is preferably the case that the at least one external flattened formation is formed along an entire length of the external circumference, and/or the at least one internal convexity is formed along an entire length of the internal holder of the accommodating portion, and/or the at least one internal-convexity part is formed along an entire length of the internal holder of the output shaft, and/or the at least one external flattened region is formed along the entire shank. It is therefore possible to provide for an easy and cost-effective production of the at least one external flattened formation, the at least one internal convexity, of the at least one internal-convexity part and/or of the at least one external flattened region.

It is preferably the case that the accommodating portion has two internal convexities and the output shaft has an internal-convexity part. A suitable drive shaft and a suitable output shaft can therefore be provided in an easy manner.

A tool-free locking mechanism with at least one locking element for locking a bit-insert tool is preferably provided on the accommodating portion. It is thus possible to provide for a secure and robust arrangement of the bit-insert tool in the accommodating portion.

According to one embodiment, the locking mechanism is designed to lock the coupling part on the accommodating portion. It is thus possible to provide for a stable and efficient locking of the coupling part.

The output shaft is preferably assigned a locking device for locking the bit-insert tool in the output shaft. It is thus possible to provide for secure and uncomplicated locking of the bit-insert tool in the output shaft.

The present invention also provides a tool system having a portable power tool, which has a tool holder for accommodating an insert tool, and having a quick-release adapter for operating an insert tool on the portable power tool, wherein the quick-release adapter has a drive shaft for arranging in a tool holder of the portable power tool, and is provided with an accommodating portion, which is connected to the drive shaft and is provided with an internal holder. The internal holder is designed to accommodate an output shaft, wherein the output shaft has an internal holder for accommodating an insert tool, wherein the internal holder of the output shaft is at least partially of a sleeve-like design and, at least in part, has an internal-convexity part, and wherein the insert tool has an at least partially cylindrical shank with at least one external flattened region, which is adapted to the at least one internal-convexity part.

The invention therefore makes it possible to provide a tool system in the case of which the at least one internal-convexity part in the internal holder and the at least one external flattened region, which is adapted to the at least one internal-convexity part, can provide for easy and precise centering of the insert tool in the quick-release adapter. It is thus possible to provide for sure and reliable transmission of a torque from the quick-release adapter to the insert tool.

The internal holder of the accommodating portion is preferably designed to accommodate a coupling part, wherein the coupling part has an internal holder for accommodating the output shaft. It is therefore easily possible to provide an arrangement of the output shaft.

It is preferably the case that the internal holder of the accommodating portion is at least partially of a sleeve-like design and, at least in part, has at least one internal convexity, wherein the coupling part has an at least partially cylindrical outer circumference with at least one outer flattened formation, which is adapted to the at least one internal convexity. A suitable internal holder can therefore be provided in an easy and uncomplicated manner.

### BRIEF DESCRIPTION OF THE DRAWINGS

The invention will be explained in more detail in the following description with reference to exemplary embodiments illustrated in the drawings, in which:

FIG. 1 shows a schematic view of a portable power tool with a tool holder,

FIG. 2 shows an exploded view of a coupling unit with a first embodiment of an insert tool,

FIG. 3 shows a perspective view of the coupling unit with the insert tool from FIG. 2,

FIG. 4 shows a longitudinal section through a quick-release adapter with a locking mechanism and the coupling unit, and also the insert tool, from FIG. 2 and FIG. 3, and with a second embodiment of an insert tool in the uninstalled state,

FIG. 5 shows a side view of the quick-release adapter with the insert tools from FIG. 4,

FIG. 6 shows a sectional view of the quick-release adapter from FIG. 4, as seen in the direction of arrows VI-VI from FIG. 4,

FIG. 7 shows a longitudinal section through the quick-release adapter from FIG. 5 with the insert tools in the installed state,

FIG. 8 shows a sectional view of the quick-release adapter from FIG. 7, as seen in the direction of arrows VIII-VIII from FIG. 7,

FIG. 9 shows a side view of the insert tool from FIG. 2 to FIG. 5 and FIG. 7,

FIG. 10 shows a sectional view of the insert tool from FIG. 9, as seen in the direction of arrows X-X from FIG. 9,

FIG. 11 shows a perspective view of an output shaft, which is assigned to the coupling unit from FIG. 2,

FIG. 12 shows a side view of the output shaft from FIG. 11,

FIG. 13 shows a sectional view of the output shaft from FIG. 12, as seen in the direction of arrows XIII-XIII from FIG. 12,

FIG. 14 shows a perspective view of a coupling part, which is assigned to the coupling unit from FIG. 2,

FIG. 15 shows a side view of the coupling part from FIG. 14,

FIG. 16 shows a front view of the coupling part from FIG. 15, as seen in the direction of an arrow 1501 from FIG. 15,

FIG. 17 shows a perspective view of a drive element, which is assigned to the coupling unit from FIG. 2,

FIG. 18 shows a side view of the drive element from FIG. 17, and

FIG. 19 shows a sectional view of the drive element from FIG. 18, as seen in the direction of arrows XIX-XIX from FIG. 18.

### DESCRIPTION OF THE EXEMPLARY EMBODIMENTS

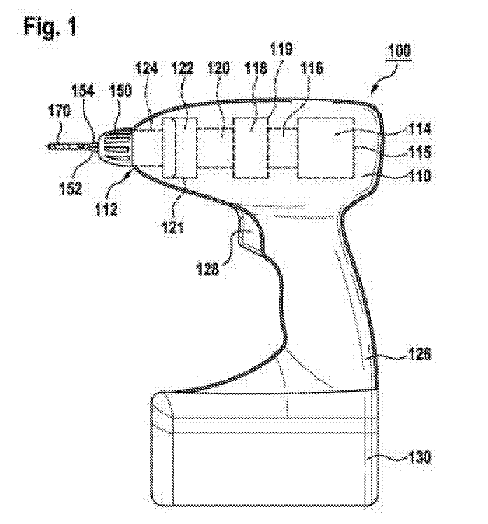

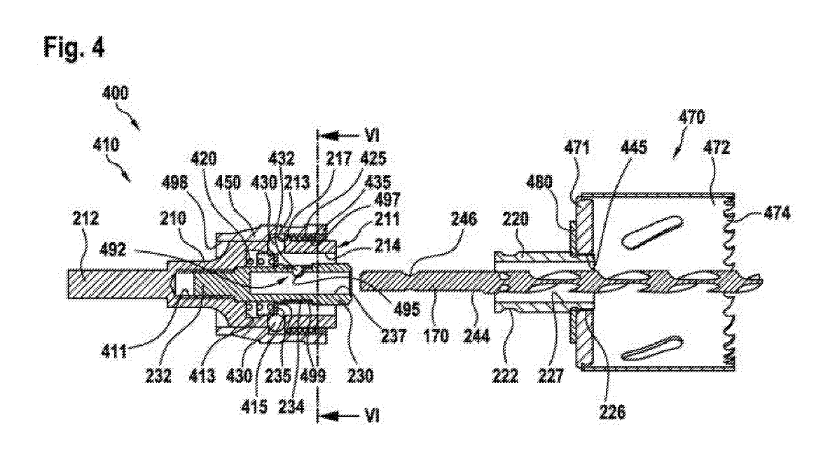

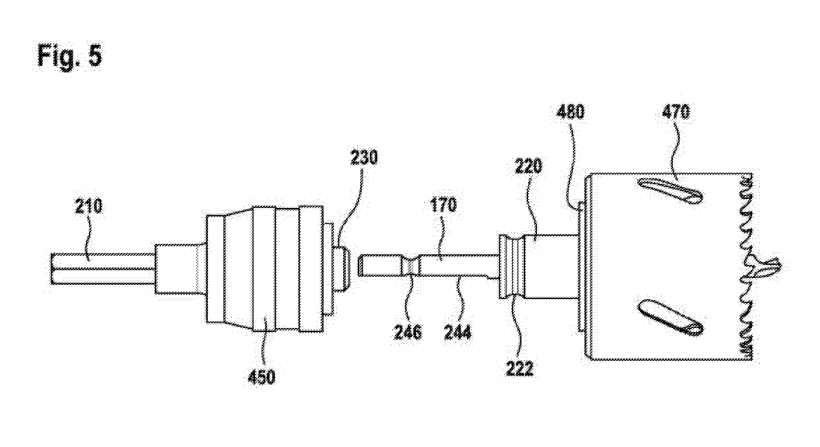

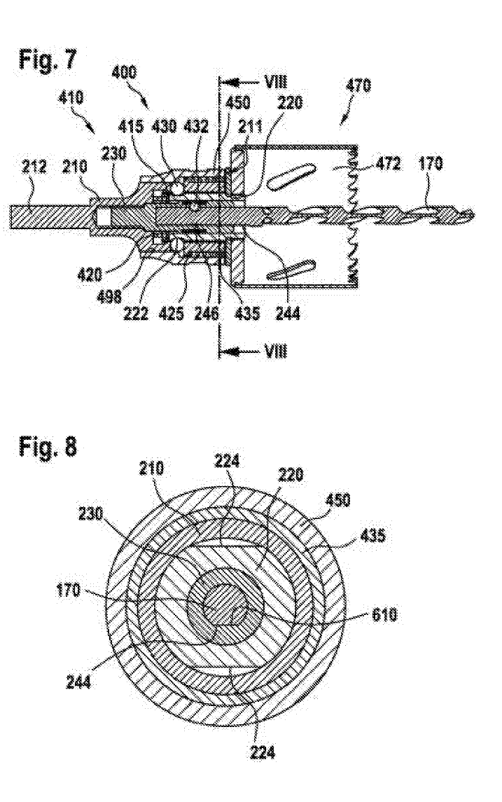

FIG. 1 shows a portable power tool 100 which is provided with a tool holder 150, has a tool housing 110 with a handle 126 and is designed, by way of example, in the form of a cordless impact driver. According to one embodiment, for off-grid power supply, the portable power tool 100 can be mechanically and electrically connected, to a rechargeable battery pack 130; as an alternative to this, however, it can also be operable, for example, in a grid-based manner. It should be pointed out, however, that the present invention, rather than being restricted to cordless impact drivers, can be used generally for tools in which use can be made of the quick-release adapter described in FIG. 4, FIG. 5 and FIG. 7 (400 in FIG. 4), irrespective of whether the tool is operated by motor and/or can be operated off-grid with a rechargeable battery pack or in a grid-based manner.

The tool housing 110 contains, by way of example, an electric drive motor 114, which is powered by the rechargeable battery pack 130, an optional transmission 118 and an optional mechanical percussion mechanism 122, wherein the drive motor 114 can be actuated, i.e. switched on and off, for example via a manual switch 128, and may be any desired type of motor, e.g. an electronically commutated motor or a DC motor. The drive motor 114 is connected to the transmission 118 via an associated motor shaft 116, said transmission converting rotation of the motor shaft 116 into rotation of a drive member 120, e.g. of a drive shaft, provided between the transmission 118 and the percussion mechanism 122. For illustrative purposes, the transmission 118 is arranged in a transmission housing 119, the drive motor 114 is arranged in a motor housing 115 and the percussion mechanism 122 is arranged in a percussion-mechanism housing 121, said housings 119, 115, 121 being arranged, by way of example, in the tool housing 110.

It should be pointed out that configuring the portable power tool 100 with a percussion mechanism 122 and/or a transmission 118 is merely an example and should not be regarded as restrictive to the invention. It is thus also possible for the portable power tool 100 to be designed without a percussion mechanism 122 and/or transmission 118.

The percussion mechanism 122, which is connected to the drive shaft 120, is, by way of example, a rotary percussion mechanism which generates high-intensity impact-like angular momentum and transmits the latter to an output shaft 124, e.g. an output spindle. An example of a percussion mechanism which can realize the percussion mechanism 122 is sufficiently known from the prior art, and therefore, in order to keep the description concise, a detailed description of the percussion mechanism 122 can be dispensed with here.

The tool holder 150, which is designed preferably to accommodate insert tools 170, is arranged on the output shaft 124, in the region of an end side 112 of the tool housing 110. Said tool holder is provided by way of example, in the manner of a (drill) chuck, with preferably three clamping jaws 152, 154. It should be pointed out, however, that the tool holder 150 can also be designed with a polygonal internal holder for accommodating an insert tool 170 designed in the form of a screwdriver bit.

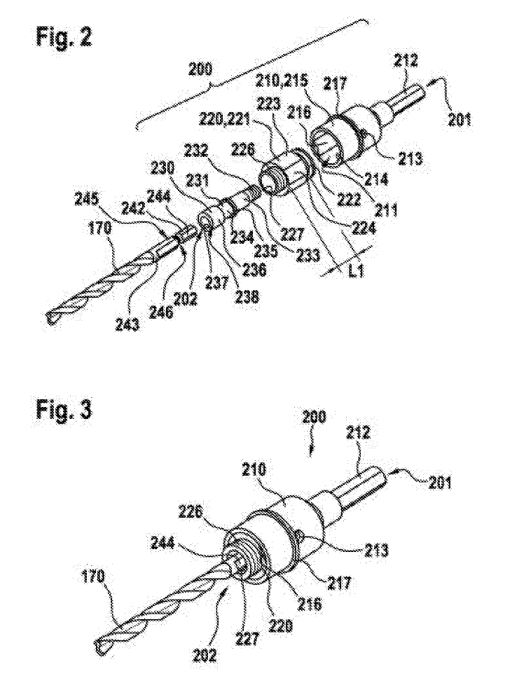

FIG. 2 shows a coupling unit 200 of a quick-release adapter (400 in FIG. 4) and the insert tool 170 from FIG. 1. The coupling unit 200 has a first and a second end 201, 202 and at least one drive element 210, with a drive shaft 212 for arranging in the tool holder 150 of the portable power tool 100 from FIG. 1, and an output shaft 230 for accommodating the insert tool 170 from FIG. 1. The drive shaft 212 here is designed preferably in the form of a hexagonal shank, but can also form any other desired shape, e.g. a round shank. Furthermore, the shank can also be designed in accordance with the SDS Plus standard and/or SDS Quick standard.

According to one embodiment, the drive element 210 has a preferably cylindrical main body with an end side 211. The main body here forms an accommodating portion 215 of the drive element 210 and is preferably designed with an internal holder 214 in which to arrange at least part of the output shaft 230. The accommodating portion 215 or the end side 211 preferably faces the second end 202 and the drive shaft 212 faces the first end 201. Furthermore, the accommodating portion 215 has an annular collar 217 on its external circumference and/or is provided with an aperture 213 in which to arrange a locking element (430 in FIG. 4) of the locking mechanism (410 in FIG. 4).

It is preferably the case that the output shaft 230 has a preferably cylindrical main body 236 with an end side 238. The end side 238 faces the second end 202 and a shank portion 232 faces the first end 201. The main body 236 here preferably has an internal holder 237 in which to arrange the insert tool 170. The shank portion 232 is preferably designed with an external thread for rotationally fixed arrangement in the drive element 210. An accommodating region 234 is preferably formed between the main body 236 and the shank portion 232. The accommodating region 234 is subdivided into a first and a second sub-region 231, 233, preferably by an annular collar 235. The first sub-region 231 is arranged between the annular collar 235 and the main body 236 and the second sub-region 233 is arranged between the annular collar 235 and the shank portion 232. The first sub-region 231 here is preferably designed to accommodate a spring element (499 in FIG. 4).

The insert tool 170, which is designed by way of example in the form of a drill bit, has a shank 245 with preferably a locking groove 246 and is preferably designed in the form of a bit-insert tool 170. The locking groove 246 subdivides the shank 245 into a first and a second region 242, 243, wherein, for illustrative purposes, the first region faces the first end 201. The shank 245 is at least partially cylindrical. According to one embodiment, at least the second region 243 is of a cylindrical design. The first region 242 here is preferably of a hexagonal design. According to a further embodiment, the first and second regions 242, 243 are cylindrical.

It should be pointed out that configuring the insert tool 170 in the form of a drill bit is merely an example and should not be regarded as being restrictive to the invention. It is thus also possible for the insert tool 170 to be designed, for example, in the form of a screwdriver bit.

According to one embodiment, the coupling unit 200 is assigned a coupling part 220 with a preferably at least partially cylindrical main body 221, which has an external circumference 223. The main body 221 has a length L1. At its end which faces the first end 201 of the coupling unit 200, the coupling part 220 is provided with a locking groove 222 for locking to the drive element 210. At its end which faces the second end 202, the coupling part 220 has an accommodating region 226 on which to arrange an insert tool designed in the form of a hole saw (470 in FIG. 4). The accommodating region 226 preferably has a smaller external diameter than the main body. In addition, the accommodating region 226 is preferably provided with an external thread. Furthermore, the coupling part 220 has a through-passage opening 227 designed in the form of an internal holder. The internal holder 227 is preferably designed to accommodate the output shaft 230, wherein the internal holder 214 of the drive element 210 is designed to accommodate the coupling part 220.

Such a coupling unit 200 with the drive element 210, the output shaft 230 and the optional coupling part 220 is already known, in principle, from EP 1 193 014 B1, the disclosure of which is included explicitly in the present description. Therefore, in order to keep the description concise, a detailed description of the coupling unit, with the exception of the elements shown and described, will be dispensed with hereinbelow.

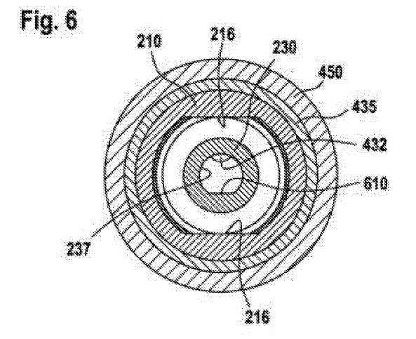

According to one embodiment, the internal holder 237 of the output shaft 230 is at least partially of a sleeve-like design and, at least in part, has an internal-convexity part (610 in FIG. 6). The insert tool 170 here preferably has the at least partially cylindrical shank 245, which preferably has at least one external flattened region 244, which is adapted to the at least one internal-convexity part (610 in FIG. 6). It is possible here for part of the at least one internal-convexity part (610 in FIG. 6) to face the first or second end 201, 202 of the coupling unit 200. In the case of a design in which it faces the first end 201, the at least one internal-convexity part (610 in FIG. 6) is preferably spaced apart from the end side 238, wherein the external flattened region 244 is formed merely on part of the shank 245 or in the first region 242.

It is also possible for the at least one internal-convexity part (610 in FIG. 6) to be formed along an entire length of the internal holder 237, wherein the at least one external flattened region 244 can be formed along the entire shank 245. In addition, it is also possible for there to be formed a plurality of internal-convexity parts (610 in FIG. 6), which can be formed in the radial and/or axial direction of the output shaft 230, wherein, as described above, the external flattened region 244 is adapted to the internal-convexity part (610 in FIG. 6).

In addition, it is preferably the case that the internal holder 214 of the accommodating portion 215 is at least partially of a sleeve-like design and, at least in part, has at least one internal convexity 216. The at least partially cylindrical external circumference 223 here, which is assigned to the coupling part 220, has at least one external flattened formation 224. The at least one external flattened formation 224 is adapted to the at least one internal convexity 216. It is possible here for part of the at least one internal convexity 216 to face the first or second end 201, 202 of the coupling unit 200. In the case of a design in which it faces the first end 201, the at least one internal convexity 216 is preferably spaced apart from the end side 211, wherein the outer flattened formation 224 is formed merely on part of the external circumference 223, in the region of the locking groove 222.

It is also possible for the internal convexity 216 to be formed along an entire length of the internal holder 214, wherein the at least one external flattened formation 224 can be formed along the entire length L1 of the main body 221 or of the external circumference 223. In addition, it is also possible for there to be formed a plurality of internal convexities 216, which can be formed in the radial and/or axial direction of the drive element 210, wherein, as described above, the external flattened formation 224 is adapted to the internal convexity 216.

The at least one partial external flattened formation 224 and/or the at least one partial external flattened region 244 are/is designed preferably to transmit torque. The drive shaft 212 preferably has two internal convexities 216 and/or the output shaft 230 preferably has an internal-convexity part 610.

FIG. 3 shows the coupling unit 200 from FIG. 2 with the bit-insert tool 170 from FIG. 1 and FIG. 2 in the assembled state. The coupling part 220 here is arranged in the drive element 210, wherein the output shaft 230 is arranged in the coupling part 220 and is mounted in the drive element 210. In addition, the bit-insert tool 170 is arranged in the output shaft 230.

FIG. 4 shows a quick-release adapter 400 with the coupling unit 200 from FIG. 2 and FIG. 3 and with a locking mechanism 410. The quick-release adapter 400 preferably forms a tool system with the portable power tool 100 from FIG. 1. FIG. 4 here depicts the arrangement of the output shaft 230 in the drive element 210. The internal holder 214 of the drive element 210 tapers into a holder 411, preferably going from the end side 211 in the direction of the drive shaft 212. The shank portion 232 of the output shaft 230 is preferably arranged in a rotationally fixed manner in the holder 411. It is preferably the case that the shank portion 232 is arranged in a rotationally fixed manner in the holder 411 via a screw connection, wherein the shank portion 232, which is preferably provided with an external thread, is connected to an internal thread of the holder 411.

A tool-free locking mechanism 410 is preferably arranged on the accommodating portion 215. The locking mechanism 410 is preferably designed to lock the coupling part 220 on the accommodating portion 215. The locking mechanism 410 here is provided with at least one locking element 430, 432 for locking an insert tool 170, 470. The locking elements 430, 432 are preferably designed in the form of balls.

In addition, the locking mechanism 410 is assigned, at least for unlocking purposes, an actuating sleeve 450. The actuating sleeve 450 has a cylindrical accommodating region 498, which is mounted in an axially movable manner on the accommodating portion 215 or between the annular collar 217 and the drive shaft 212. The accommodating region 498 widens, in the direction of the end side 211 of the drive element 210, into a region 497, and therefore the annular collar 217 is arranged in this region 497. It is also the case that the actuating sleeve 450 is subjected to spring action by a spring element 425. The spring element 425 is arranged between the annular collar 217 and an annular disk 435. The annular disk 435, in contrast, is arranged radially between the actuating sleeve 450 and the drive element 210. The annular disk 435 here can be moved with the actuating sleeve 450 and/or the region 497. In the position which is shown in FIG. 4, the spring element 425 is compressed. A locking element 430 is arranged here in the aperture 213, which is preferably designed in the form of a through-passage opening. For illustrative purposes, two locking elements 430 are shown, the two locking elements 430 being arranged diametrically opposite one another.

For illustrative purposes, the locking elements 430 in FIG. 4 have been forced radially into the region 497 of the actuating sleeve 450 by a preferably cup-like element 415. The element 415 here is subjected to spring action in the axial direction by a spring element 420, wherein the element 415 is forced against the annular collar 235. The spring element 420 is supported on a base surface 413 of the internal holder 214. The base surface 413 causes the internal holder 214 to taper into the holder 411.

According to one embodiment, the output shaft 230 is assigned a locking device 492 for locking the bit-insert tool 170 in the output shaft 230. The locking device 492 is arranged in the first sub-region 231 of the accommodating region 234. The locking device 492 here has at least one locking element 432 and a clamping ring 499.

The clamping ring 499 has an aperture for accommodating part of the locking element 432. The clamping ring 499 is preferably designed to force the locking element 432 radially into the internal holder 237. It is also the case that the first sub-region 231 has an aperture 495 in which to arrange part of the locking element 432, wherein the aperture 495 is designed such that the locking element 432 does not fall into the internal holder 237.

Furthermore, FIG. 4 depicts an insert tool 470 designed in accordance with a second embodiment. The insert tool 470 is designed preferably in the manner of a hole saw. The hole saw 470 has, by way of example, a cup-like saw portion 472, which is provided with saw teeth 474. At its axial end which is located opposite the saw teeth 474, the hole saw 470 has an accommodating flange 471. The accommodating flange 471 has an aperture 445 for rotationally fixed arrangement on the coupling part 220 or on the accommodating region 226 thereof.

The aperture 445 preferably has an internal thread for connection to the external thread of the accommodating region 226. The accommodating flange 471 here is arranged on the coupling part 220 such that it butts against an annular disk 480. The annular disk 480 is arranged on the coupling part 220. In addition, the bit-insert tool 170 in FIG. 4 is arranged in the internal holder 227. It should be pointed out that it is also possible for the hole saw 470 to be connected to the coupling part 220 via any other desired connection, e.g. by a press-fit connection. Furthermore, it is also possible for the hole saw 470 to be formed in one piece with the coupling part 220.

FIG. 5 shows the quick-release adapter 400 from FIG. 4 with the bit-insert tool 170 and the hole saw 470. FIG. 5 depicts the axially movable actuating sleeve 450, which is arranged on the drive element 210.

FIG. 6 shows the quick-release adapter 400 from FIG. 4 and FIG. 5 without the coupling part 220 and without the two insert tools 170, 470. FIG. 6 depicts the preferably two preferably diametrically opposite internal convexities 216 of the drive element 210. FIG. 6 also shows the arrangement of part of the locking element 432 in the internal holder 237. In addition, FIG. 6 depicts the at least partially sleeve-like internal holder 237, which preferably has, at least in part, an internal-convexity part 610. The external flattened region 244 of the bit-insert tool 170 here is adapted to the at least one internal-convexity part 610.

FIG. 7 shows the quick-release adapter 400 with the locking mechanism 410, which locks the bit-insert tool 170 and the hole saw 470. The locking element 432 here, which is arranged in the output shaft 230, is arranged in the locking groove 246 of the bit-insert tool 170 and fixes the bit-insert tool 170 in the quick-release adapter 400. In addition, the coupling part 220 forces the element 415 in the direction of the drive shaft 212, as a result of which the spring element 420 is compressed. The locking element 430 is thus released and moves along an external contour of the coupling part 220 into the locking groove 222. The locking element 430 here moves in the radial direction toward the coupling part 220, wherein, on account of the spring action of the spring element 425, the actuating sleeve 450 moves in the direction of the end side 211 of the drive element 210. The accommodating region 498 here forces the locking element 430 radially inward and/or toward the coupling part 220.

During an unlocking operation, the actuating sleeve 450 moves in the direction of the drive shaft 212, as a result of which the locking element 430 can move radially outward and/or away from the coupling part 220. As a result, the insert tools 170, 470 are released and can be removed from the quick-release adapter 400.

FIG. 8 shows the quick-release adapter 400 from figure with the coupling part 220 and the two insert tools 170, 470. FIG. 8 depicts the at least one partial internal-convexity part 610 and the external flattened region 244 of the bit-insert tool 170.

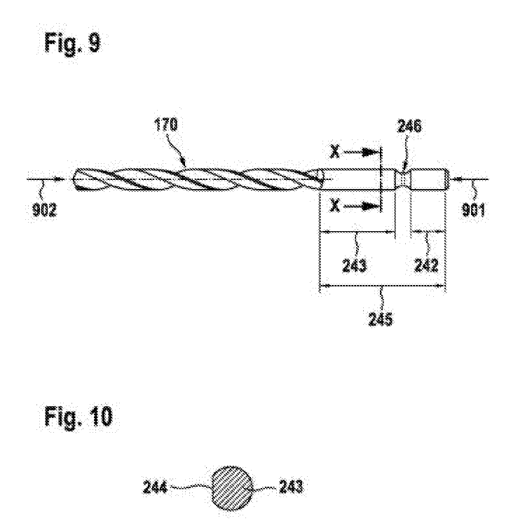

FIG. 9 shows the bit-insert tool 170 from FIG. 2 with a first and a second end 901, 902. The shank 245 with the locking groove 246 is preferably formed at the first end 901. As described above, the locking groove 246 subdivides the shank 245 into the first and second regions 242, 243, wherein the first region 242 faces the first end 901 and the second region 243 faces the second end 902. The shank 245 here is preferably at least partially cylindrical, wherein preferably at least the second region 243 is of a cylindrical design. The first region 242 here is preferably of a hexagonal design. According to a further embodiment, the first and second regions 242, 243 are cylindrical.

FIG. 10 shows the bit-insert tool 170 from FIG. 9 and depicts the external flattened region 244 of the bit-insert tool 170. FIG. 10 also depicts the preferably cylindrical shank 245 and the cylindrical second region 243.

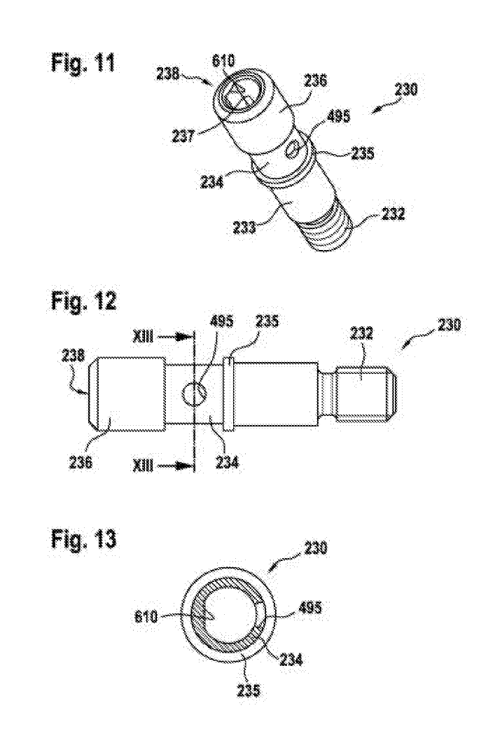

FIG. 11 shows the output shaft 230 from FIG. 2 and FIG. 4 to FIG. 8 and depicts the internal-convexity part 610, which is formed in the internal holder 237.

FIG. 11 also depicts the aperture 495 in which to arrange part of the locking element 432 of the locking device 492, said aperture being formed in the first sub-region 231.

FIG. 12 shows the output shaft 230 from FIG. 11 and depicts the arrangement of the aperture 495 in the accommodating region 234. The aperture 495 here is preferably arranged centrally in the axial direction of the output shaft 230, but could also be offset in an axial direction.

FIG. 13 shows the output shaft 230 from FIG. 11 and FIG. 12 and depicts the arrangement of the internal-convexity part 610. The internal-convexity part 610 is preferably formed diametrically opposite the aperture 495, but could also be formed in any other desired manner in relation to the aperture 495.

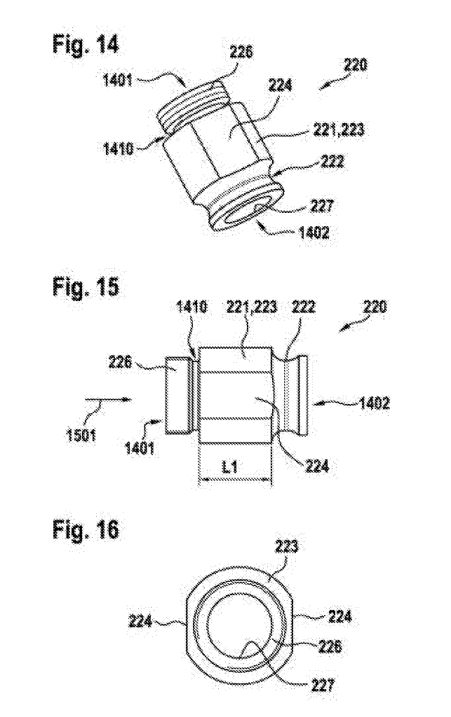

FIG. 14 shows the coupling part 220 from FIG. 2 with a first and a second end 1401, 1402. The locking groove 222 here is arranged at the second end 1402 and the accommodating region 226 is arranged at the first end 1401. FIG. 14 also depicts an accommodating groove 1410 in which to arrange the annular disk 480 of the hole saw 470. The accommodating groove 1410 is preferably formed between the main body 221 with the outer circumference 223 and the accommodating region 226.

FIG. 15 shows the coupling part 220 from FIG. 14 and depicts the length L1 of the main body. As described above, the at least one external flattened formation 224 in FIG. 15 is formed along the entire length L1 of the main body 221, or of the external circumference 223, but can also be formed only on part of the external circumference 223, in the region of the locking groove 222.

FIG. 16 shows the coupling part 220 from FIG. 14 and FIG. 15 and depicts the preferably two external flattened formations 224. For illustrative purposes, and preferably, the two external flattened formations 224 are arranged diametrically opposite one another, but could also be arranged in any desired manner in relation to one another.

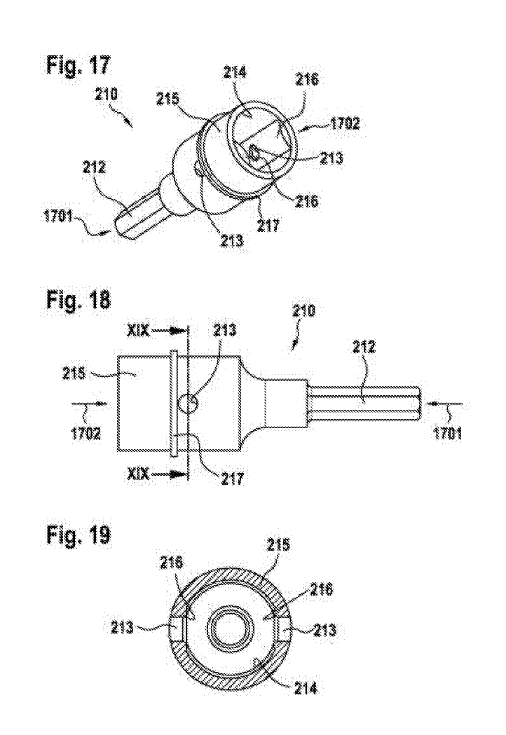

FIG. 17 shows the drive element 210 from FIG. 2 with a first and a second end 1701, 1702. The drive shaft 212 here is arranged at the first end 1701 and the accommodating portion 215 is arranged at the second end 1702.

FIG. 18 shows the drive element 210 from FIG. 17 and depicts the aperture 213 in which to arrange the locking element 430 of the locking mechanism 410. The aperture 213 here faces the first end 1701 and is formed in the region of the annular collar 217.

FIG. 19 shows the drive element 210 from FIG. 17 and FIG. 18 and the preferably two internal convexities 216. For illustrative purposes, and preferably, the two internal convexities 216 are formed diametrically opposite one another. The aperture 213 here, which is designed preferably in the form of a through-passage hole, is formed in the region of the internal convexities 216.

1. A quick-release adapter for operating an insert tool on a portable power tool, comprising:
a drive shaft configured to be arranged in a tool holder of the portable power tool; and
an accommodating portion connected to the drive shaft and including a first internal holder configured to accommodate an output shaft,
wherein the output shaft includes a second internal holder configured to accommodate the insert tool, the insert tool having an at least partially cylindrical shank with at least one external flattened region,
wherein the second internal holder of the output shaft includes a sleeve-like portion and, at least in part, at least one first internal-convexity part, and
wherein the at least one external flattened region is adapted to the at least one first internal-convexity part.

2. The quick-release adapter as claimed in claim 1, wherein:
the first internal holder of the accommodating portion is configured to accommodate a coupling part; and
the coupling part includes a third internal holder configured to accommodate the output shaft.

3. The quick-release adapter as claimed in claim 2, wherein:
the first internal holder of the accommodating portion includes a sleeve-like portion design and, at least in part, at least one second internal convexity; and
the coupling part includes an at least partially cylindrical external circumference having at least one external flattened formation adapted to the at least one second internal convexity.

4. The quick-release adapter as claimed in claim 3, wherein the at least one external flattened formation and/or the at least one external flattened region is configured to transmit torque.

5. The quick-release adapter as claimed in claim 3, wherein the at least one external flattened formation is arranged along an entire first length of the at least partially cylindrical external circumference, and/or the at least one second internal convexity is arranged along an entire second length of the first internal holder of the accommodating portion, and/or the at least one first internal-convexity part is arranged along an entire third length of the second internal holder of the output shaft, and/or the at least one external flattened region is arranged along the entire at least one partially cylindrical shank.

6. The quick-release adapter as claimed in claim 1, wherein the accommodating portion includes two second internal convexities and the output shaft includes a first internal-convexity part of the at least one first internal-convexity part.

7. The quick-release adapter as claimed in claim 2, further comprising:
a tool-free locking mechanism including at least one locking element configured to lock the insert tool, the tool-free locking mechanism arranged on the accommodating portion.

8. The quick-release adapter as claimed in claim 7, wherein the tool-free locking mechanism is configured to lock the coupling part on the accommodating portion.

9. The quick-release adapter as claimed in claim 1, wherein the output shaft is assigned a locking device configured to lock the insert tool in the output shaft.

10. A tool system, comprising:
a portable power tool including:
a tool holder configured to accommodate an insert tool and
a quick-release adapter configured to operate the insert tool on the portable power tool, the quick-release adapter including:
a drive shaft configured to be arranged in the tool holder of the portable power tool; and
an accommodating portion connected to the drive shaft and including a first internal holder, the first internal holder configured to accommodate an output shaft,
wherein the output shaft includes a second internal holder configured to accommodate the insert tool, the insert tool having an at least partially cylindrical shank with at least one external flattened region,
wherein the second internal holder of the output shaft includes a sleeve-like portion and, at least in part, at least one first internal-convexity part, and
wherein the at least one external flattened region adapted to the at least one first internal-convexity part.

11. The tool system as claimed in claim 10, wherein:
the first internal holder of the accommodating portion is configured to accommodate a coupling part; and
the coupling part includes a third internal holder configured to accommodate the output shaft.

12. The tool system as claimed in claim 11, wherein:
the first internal holder of the accommodating portion includes a sleeve-like portion and, at least in part, at least one second internal convexity; and
the coupling part includes an at least partially cylindrical external circumference having at least one external flattened formation adapted to the at least one second internal convexity.
